(19) United States
(12) Patent Application Publication
(10) Pub. No.: US 2023/0264891 A1
(43) Pub. Date: Aug. 24, 2023

(54) Wastebasket

(71) Applicant: Bob Barker Company, Inc., Fuquay-Varina, NC (US)

(72) Inventors: Gerrad Stephen Allison, Angier, NC (US); Lena Renee Butterfield, Loveland, CO (US)

(21) Appl. No.: 18/109,552

(22) Filed: Feb. 14, 2023

Related U.S. Application Data
(60) Provisional application No. 63/312,579, filed on Feb. 22, 2022.

(51) Int. Cl. B65F 1/02; B65D 1/42

(52) U.S. Cl. CPC B65F 1/02; B65D 1/42; B65F 2250/114

(57) ABSTRACT

A wastebasket that includes a body with a unitary, one-piece construction. The body has a bottom and sidewalls that extend from the bottom with the sidewalls having a top edge that is exposed and positioned opposite from the bottom. The top edge has an undulating shape that prevents the wastebasket from being used as a stool.

### RELATED APPLICATIONS

This application claims priority to U.S. Provisional Application No. 63/312,579, filed Feb. 22, 2022, the disclosure of which is incorporated herein by reference in its entirety.

### BACKGROUND

Correctional facilities such as but not limited to prisons, jails, mental health facilities, and detention centers, use wastebaskets. These wastebaskets are used in areas where inmates are housed, such as but not limited to kitchens, bathrooms, meeting spaces, personal spaces, and various common areas. The wastebasket can be used to contain various different types of objects, such as but not limited to paper, discarded food, and various other discarded items.

An issue with items like wastebaskets in this environment in the inmates may try to use the components as a weapon to injure themselves and/or another person. The wastebaskets should be constructed in a manner to prevent and/or reduce the ability for use as a weapon.

A wastebasket in these facilities can also be used to as a stool for an inmate to stand. The inmate could then be able to access and area or a device which is off-limits. For example, an inmate may attempt to stand on a wastebasket to access a light or a sprinkler system that is attached to the ceiling. The wastebasket should be designed to prevent its use in this manner.

### SUMMARY

One aspect is directed to a wastebasket comprising a body with a unitary, one-piece construction. The body comprises a bottom and sidewalls that extend from the bottom with the sidewalls comprising a top edge that is exposed and positioned opposite from the bottom. The top edge comprises an undulating shape that varies along a length and with a continuous curvature.

In another aspect, the body is constructed from silicone to provide for the sidewalls to be self-supporting and to prevent use as a stool.

In another aspect, the undulating shape of the top edge includes that less than 10% of a surface area of the top edge contacts against a floor when the body is inverted and positioned on the floor.

In another aspect, an interior space is formed by the bottom and the sidewalls with the interior space comprising a tapered shape that is smaller at the bottom and larger at the top edge.

In another aspect, the sidewalls comprise four planar walls.

In another aspect, the sidewalls comprise one or more ribs that are vertically aligned and extend between the bottom and the top edge with the ribs comprising a larger thickness than a remainder of the sidewalls.

In another aspect, the body comprises a polygonal shape with the ribs positioned in corners of the body.

One aspect is directed to a wastebasket comprising a bottom and sidewalls that extend upward from the bottom with the sidewall having a top edge that is opposite from the bottom. The top edge comprises an uneven shape. Two of sidewalls are positioned on opposing sides of the bottom and comprising different heights measured between the bottom and the top edge for the bottom to be aligned an at angle of at least 45° to prevent a person from standing on the bottom when the wastebasket is inverted and positioned on a floor.

In another aspect, the body is constructed from silicone.

In another aspect, the top edge has a continuous curved shape that is devoid of flat areas.

In another aspect, an interior space is formed by the bottom and the sidewalls with the interior space comprising a tapered shape that is smaller at the bottom and larger at the top edge.

In another aspect, the sidewalls comprise four planar walls with rounded corners.

In another aspect, the sidewalls comprise ribs at the rounded corners and that extend between the bottom and the top edge with the ribs comprising a larger thickness than a remainder of the sidewalls.

In another aspect, the top edge has a mirrored shape about a centerline that extends across a center of the bottom.

In another aspect, the body is constructed from a single piece of silicone.

One aspect is directed to a wastebasket comprising a body with a unitary, one-piece construction. The body comprises a bottom, and sidewalls that extend from the bottom with the sidewalls comprising a top edge that is exposed and positioned opposite from the bottom. The top edge comprises an undulating shape that varies along a length and with a continuous curvature. The top edge is shaped such that between 5%-10% of a surface area of the top edge contacts against a floor when the body is inverted.

In another aspect, the body is constructed from a single piece of silicone.

In another aspect, the continuous curvature of the top edge does not include any flat sections.

In another aspect, the sidewalls comprise four planar walls with rounded corners and with the rounded corners comprising a larger thickness than the planar walls.

One aspect is directed to a wastebasket comprising a unitary, one-piece body with a bottom and a sidewall that extends from the bottom with the bottom and sidewall extending around and forming an interior space. The sidewall comprises an exposed top edge with an uneven shape.

In another aspect, the top edge has a continuous curved shape.

In another aspect, the top edge has no flat areas along the length.

In another aspect, the wastebasket is constructed from silicone.

In another aspect, the top edge comprises a shape with less than 10% of the surface area of the top edge contacting against a support floor when the wastebasket is inverted and positioned on the floor.

In another aspect, the body is constructed from a flame-resistant material.

In another aspect, the body is constructed from a fracture-resistant material.

One aspect is directed to a wastebasket comprising a bottom and a sidewall that extends upward from the bottom with the sidewall having a top edge that is opposite from the bottom. The top edge comprises an uneven shape. The bottom and sidewall are constructed from a synthetic material.

In another aspect, the bottom and sidewall are constructed from silicone

In another aspect, the bottom and sidewall are constructed from a synthetic material.

In another aspect, the bottom and sidewall comprise a unitary, one-piece construction.

In another aspect, the top edge has a continuous curved shape.

In another aspect, the top edge has no flat areas along the length.

In another aspect, the body is constructed from a flame-resistant material.

In another aspect, the body is constructed from a fracture-resistant material.

In another aspect, the top edge comprises a shape with less than 10% of the surface area of the top edge contacting against a support floor when the wastebasket is inverted and positioned on the floor.

In another aspect, the interior space has a tapered shape that is smaller at the bottom and larger at the top edge of the sidewall.

### BRIEF DESCRIPTION OF THE DRAWINGS

FIG. 1A is a perspective view of a wastebasket.

FIG. 1B is a side view of the wastebasket of FIG. 1A.

FIG. 10 is a schematic diagram of a top edge of a sidewall of a wastebasket.

FIG. 2A is a perspective view of a wastebasket.

FIG. 2B is a side view of the wastebasket of FIG. 2A.

FIG. 2C is a schematic diagram of the wastebasket of FIGS. 2A and 2B in an inverted orientation.

FIG. 3 is a perspective view of a wastebasket.

FIG. 4 is a perspective view of a wastebasket.

FIG. 5 is a perspective view of a wastebasket.

FIG. 6 is a perspective view of a wastebasket.

FIG. 7 is a perspective view of a wastebasket.

FIG. 8 is a section view cut along line XIII-XIII of FIG. 7.

FIG. 9 is a section view cut along line IX-IX of FIG. 6.

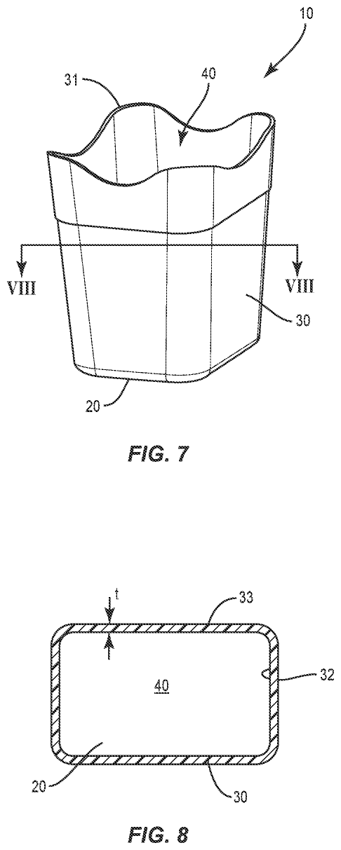

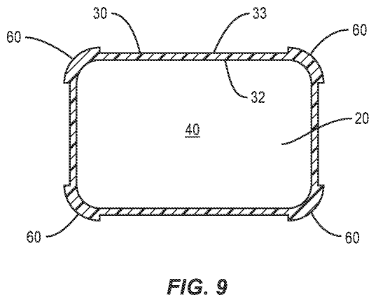

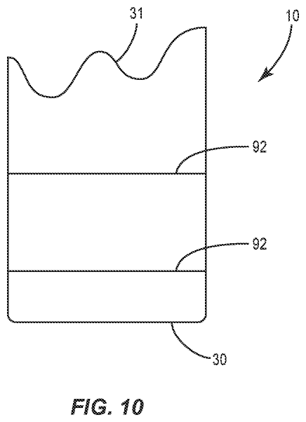

FIG. 10 illustrates a side view of a wastebasket that includes bands that extend around the perimeter.

### DETAILED DESCRIPTION

The present application is directed generally to a wastebasket. The wastebasket includes a body with an interior space configured to hold objects. The wastebasket is designed for use in an institutional facility to prevent its use as a stool on which a person could stand. The design includes a non-planar top edge. The design also includes the sidewall being made from a pliable material that is self-supporting but unable to support the weight of the person. These two design features prevent the wastebasket from being used by a person to gain access to items and/or areas that are off-limits or otherwise should not be accessed. The pliable material further prevents the wastebasket from being used as a weapon as it would deform if struck against person.

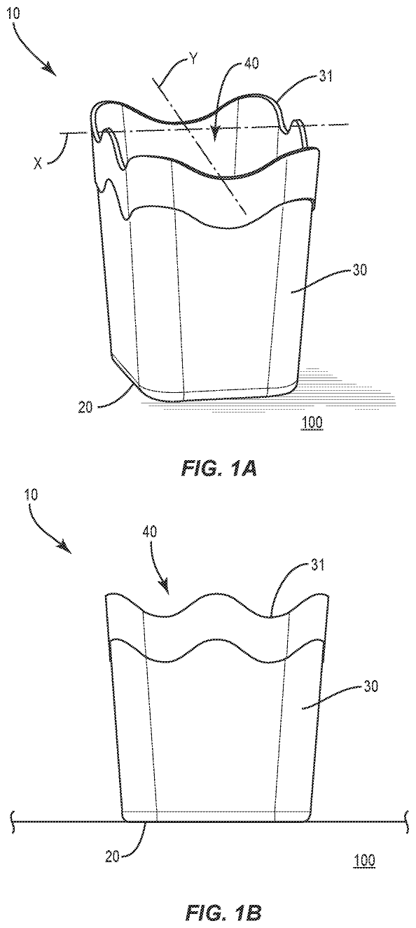

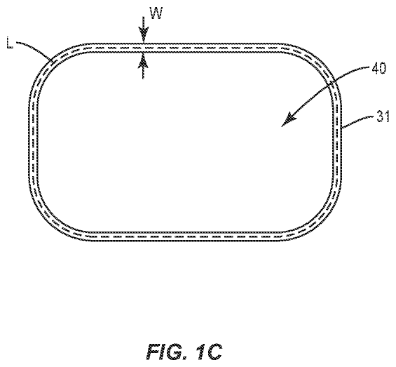

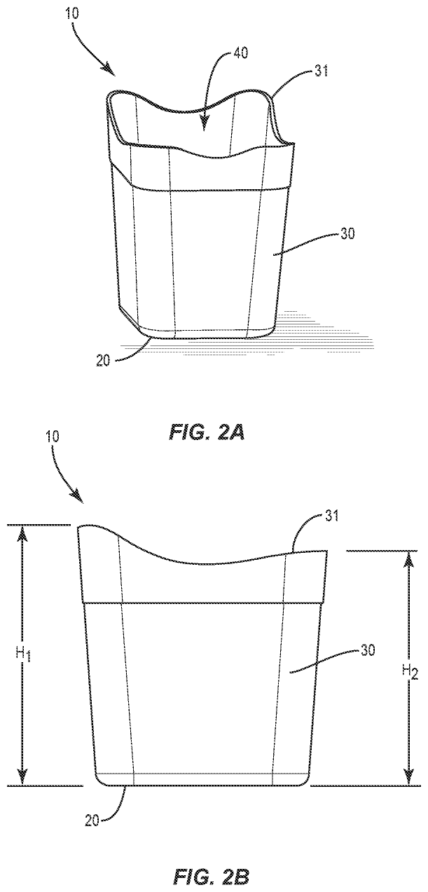

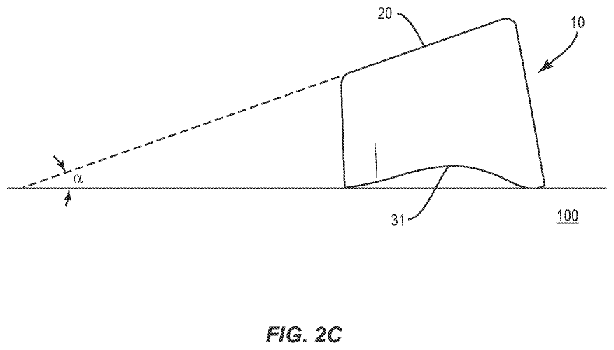

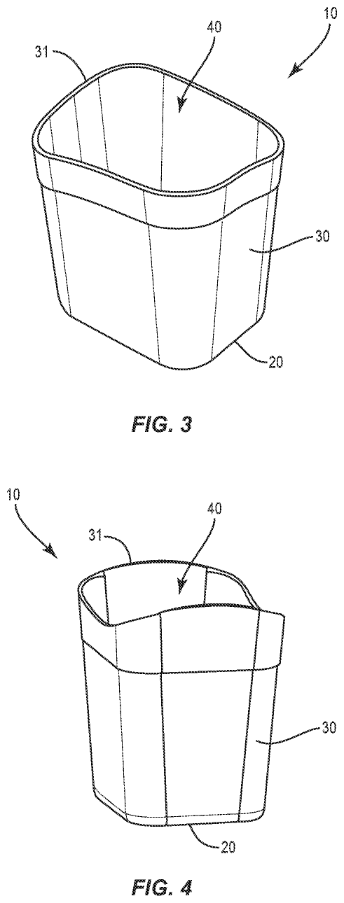

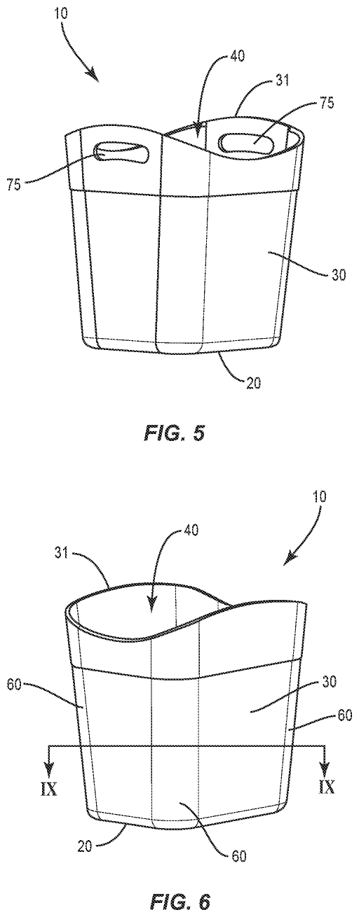

FIGS. 1A and 1B illustrate a wastebasket 10 that includes a bottom 20 and a sidewall 30. The sidewall 30 includes a top edge 31. An interior space 40 is formed by the bottom 20 and the sidewall 30 and is sized to hold the various discarded objects. The shape of the top edge 31 prevents a person from standing on the wastebasket 10. When the wastebasket 10 is in an upright position (with the bottom 20 supported by a floor 100 as illustrated in FIGS. 1A and 1B), the shape of the top edge 31 prevents the inmate from standing on it. The relatively narrow width of the top edge 31 and the interior space 40 also contribute to the inability to stand on the wastebasket 10.

In one example, the top edge 31 has an uneven shape. In one example, the top edge 31 has a non-planar shape. As illustrated in FIGS. 1A and 1B, the top edge 31 has an undulating shape that varies along the length. The top edge 31 can include a mirrored shape along one or more axes. As illustrated in FIG. 1A, the top edge 31 has a mirrored shape about both a first axis X and a second axis Y.

As illustrated schematically in FIG. 10, the top edge 31 includes a length L shown by a dashed line that extends around the entire perimeter of the interior space 40. The top edge 31 also includes a width W measured perpendicular to the length L. The top edge 31 includes an uneven shape along the length L. In one example, the non-planar top edge 31 is configured with a continuous curved shape along the entire length L. This includes the top edge 31 having no flat areas along the length L. The wastebasket 10 of FIGS. 1A and 1B includes an example of this configuration with the top edge 31 having a continuous curved shape along the length.

The top edge 31 can include a variety of different shapes and configurations. FIGS. 2A-7 illustrate examples of wastebaskets 10 each with top edges 31 having various shapes and configurations.

The top edge 31 can also be configured to prevent/reduce a person from inverting the wastebasket and standing on the bottom 20. In one example as illustrated in FIG. 2B, the top edge 31 is configured with one of the lateral sides having a greater height H1 than the opposing side H2. This difference in heights causes the bottom 20 to be aligned at an angle α when inverted and positioned on the floor 100 as illustrated in FIG. 2C. The angle α has a steepness that prevents a person from standing on the bottom 20. In one example, the top edge 31 is configured such that the angle α is at least 45°.

The top edge 31 with the uneven shape provides for a minimum amount of contact with the floor 100 when the wastebasket 10 is inverted. This minimum contact with the floor 10 further prevents the wastebasket 10 from supporting a person who attempts to stand on it while inverted. In one example, the shape of the top edge 31 results in less than 10% of the total surface area of the top edge 31 contacting against the floor 100 when the wastebasket 10 is inverted. In one example, between 5%-10% of the total surface area of the top edge 31 contacts against the floor 100. FIG. 2C schematically illustrates an example with the top edge 31 having an uneven shape such that a limited area of the top edge 31 contacts the floor 100. This lack of contact area causes the wastebasket 10 to be unsteady in the event it is used as a stool for a person to step on.

The wastebasket 10 can include different shapes and/or sizes. In one example, the bottom 20 is substantially flat with the sidewall 30 including a plurality of sides. FIGS. 1A-7 illustrate examples with the sidewall 30 include four planar sides. In one example as illustrated in FIG. 8, the wastebasket 10 has a substantially rectangular cross-sectional shape. Other examples can include different numbers of sides and different configurations. and corners. In one example, the wastebasket 10 includes a circular cross-sectional shape.

The wastebasket 10 can include holes 75 in one or more of the bottom 20 and the sidewall 30. In one example as illustrated in FIG. 5, the holes 75 form handles for grasping and handling the wastebasket 10. In another example, smaller holes 75 extend through the bottom 20. In one specific example, the holes 75 on the bottom provide for water to drain from wet laundry that is positioned in the interior space 40. The holes 75 are sized to allow for water to drain but provide for the laundry to remain in the interior space 40.

As illustrated in FIG. 8, the sidewall 30 includes a thickness t measured between an inner side 32 and an outer side 33. In one example, the thickness t is substantially constant throughout the wastebasket 10. In other examples, the thickness t varies.

In one example, the sidewall 30 includes one or more ribs 60. The ribs 60 provide strength to the sidewall 30 and can provide for the wastebasket 10 to be self-supporting. In one example as illustrated in FIG. 6, the ribs 60 are vertically aligned and extend between the top edge 31 and the bottom 20. In one example, one or more ribs 60 extend along the sidewall 30 and are aligned substantially perpendicular to the bottom 20. In one example, one or more ribs 60 are aligned at a non-perpendicular angle relative to the bottom. For example, a rib 60 can extend from a bottom right corner to a top left corner and span across various widths of the sidewall 30. In the example of FIG. 6, the ribs 60 are positioned in corners of the sidewall 30 and include a larger thickness than the other sections of the sidewall 30. In examples with multiple ribs 60, the ribs 60 can include the same or different shapes, sizes, and/or thicknesses.

In one example as illustrated in FIG. 10, the wastebasket 10 includes one or more bands 92. The bands 92 are constructed to be structurally weaker than a remainder of the sidewall 30. The bands 92 facilitate collapsing of the sidewall 30 when a person attempts to stand on the wastebasket 10. In one example, the bands 92 include a smaller thickness than the remainder of the sidewalls 30 thus providing for a weaker structure. In another example, the bands 92 are constructed from a different material than the remainder of the sidewalls 30. In another example, the bands 30 include apertures that extend through the sidewalls 30. In one example, the bands 92 extend around the entire perimeter of the wastebasket 10. In another example, the bands 92 extend around a limited section of the perimeter. In one example as illustrated in FIG. 10, the bands 92 are parallel with the bottom 20. In other examples, the bands 92 are aligned at non-parallel angles relative to the bottom 20.

The size of the interior space 40 may vary depending upon the context of use. Examples include but are not limited to a 14 quart capacity and a 28 quart capacity.

In one example, the interior space 40 is tapered that increases in size from the bottom 20 towards the top edge 31. This tapered shape provides for multiple wastebaskets 10 to be stacked together in a partially overlapping configuration when not in use.

In addition to the shape of the top edge 31, the wastebasket 10 is constructed in a manner to prevent the sidewall 30 from supporting a person who is housed in the institutional facility. In one example, this includes the sidewall 30 being pliable and unable to support a person that weighs more than 100 pounds. In the event the person were to attempt to stand on the wastebasket 10, the sidewall 30 would deform, to include but not be limited to one or more of folding and bending. The wastebasket 10 deforms, but does not break, tear or otherwise divide into multiple pieces as the individual pieces could be used by a person as a weapon to harm themselves and/or others.

The wastebasket 10 is constructed to be self-supporting. This provides for the wastebasket 10 to assume its normal shape and size for use in collecting objects for normal use. The wastebasket 10 deforms when a person attempts to stand on it, but easily returns to its original shape once the weight is removed. This provides for the wastebasket 10 to continue to be used for its intended purpose.

The wastebasket 10 is further constructed from a material that is relatively soft and deforms in the event it was to be used to hit someone or something. For example, if the wastebasket 10 was struck against a person, the wastebasket would deform and not injure the person. The wastebasket 10 is constructed to provide the appropriate durometer to be both rigid enough to maintain its shape when gripped, yet soft enough to exhibit its functional durability and pliability.

In one example, the wastebasket 10 is constructed from synthetic material. In one example, the wastebasket 10 is constructed from silicone. Other examples include but are not limited to polymeric foam (e.g., ethylene-vinyl acetate (EVA)), thermoplastic elastomers and foam rubber. In one example, the material is flame resistant. In one example, the material is fracture resistant to prevent the wastebasket from being broken into two or more pieces. In one example, the material is both flame resistant and fracture resistant.

In one example, the wastebasket 10 includes a unitary, one-piece construction. The single construction can be accomplished through suitable manufacturing methods such as injection molding. In one specific example, the entire wastebasket 10 is formed as a single piece of silicone material that is formed by injection molding.

In other examples, the wastebasket 10 is constructed from two or more separate components that are connected together such as by adhesive. In one example, the bottom 20 and sidewall 30 are separate pieces that are connected together. The separate components can be constructed from the same or different materials.

The wastebasket is configured to hold a wide variety of materials. Examples include but are not limited to various discarded items (i.e., trash), laundry, fluids, and food.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are second ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A wastebasket comprising:
a body with a unitary, one-piece construction, the body comprising:
a bottom;
sidewalls that extend from the bottom, the sidewalls comprising a top edge that is exposed and positioned opposite from the bottom;
the top edge comprising an undulating shape that varies along a length and with a continuous curvature.

2. The wastebasket of claim 1, wherein the body is constructed from silicone to provide for the sidewalls to be self-supporting and to prevent use as a stool.

3. The wastebasket of claim 1, wherein the undulating shape of the top edge includes that less than 10% of a surface area of the top edge contacts against a floor when the body is inverted and positioned on the floor.

4. The wastebasket of claim 1, further comprising an interior space formed by the bottom and the sidewalls, the interior space comprising a tapered shape that is smaller at the bottom and larger at the top edge.

5. The wastebasket of claim 1, wherein the sidewalls comprise four planar walls.

6. The wastebasket of claim 1, wherein the sidewalls comprise one or more ribs that are vertically aligned and extend between the bottom and the top edge, the ribs comprising a larger thickness than a remainder of the sidewalls.

7. The wastebasket of claim 6, wherein the body comprises a polygonal shape with the ribs positioned in corners of the body.

8. A wastebasket comprising:
a bottom;
sidewalls that extend upward from the bottom with the sidewall having a top edge that is opposite from the bottom;
wherein the top edge comprising an uneven shape;
wherein two of sidewalls positioned on opposing sides of the bottom comprising different heights measured between the bottom and the top edge for the bottom to be aligned an at angle of at least 45° to prevent a person from standing on the bottom when the wastebasket is inverted and positioned on a floor.

9. The wastebasket of claim 8, wherein the body is constructed from silicone.

10. The wastebasket of claim 8, wherein the top edge has a continuous curved shape that is devoid of flat areas.

11. The wastebasket of claim 8, further comprising an interior space formed by the bottom and the sidewalls, the interior space comprising a tapered shape that is smaller at the bottom and larger at the top edge.

12. The wastebasket of claim 8, wherein the sidewalls comprise four planar walls with rounded corners.

13. The wastebasket of claim 12, wherein the sidewalls comprise ribs at the rounded corners and that extend between the bottom and the top edge, the ribs comprising a larger thickness than a remainder of the sidewalls.

14. The wastebasket of claim 8, wherein the top edge has a mirrored shape about a centerline that extends across a center of the bottom.

15. The wastebasket of claim 8, wherein the body is constructed from a single piece of silicone.

16. A wastebasket comprising:
a body with a unitary, one-piece construction, the body comprising:
a bottom;
sidewalls that extend from the bottom, the sidewalls comprising a top edge that is exposed and positioned opposite from the bottom;
wherein the top edge comprising an undulating shape that varies along a length and with a continuous curvature; and
wherein the top edge is shaped such that between 5%-10% of a surface area of the top edge contacts against a floor when the body is inverted.

17. The wastebasket of claim 16, wherein the body is constructed from a single piece of silicone.

18. The wastebasket of claim 16, wherein the continuous curvature of the top edge does not include any flat areas.

19. The wastebasket of claim 16, wherein the sidewalls comprise four planar walls with rounded corners and with the rounded corners comprising a larger thickness than the planar walls.
